(19) United States
(12) Patent Application Publication
(10) Pub. No.: US 2016/0097788 A1
(43) Pub. Date: Apr. 7, 2016

(54) PEDESTRIAN DIRECTION OF MOTION DETERMINATION SYSTEM AND METHOD

(71) Applicant: Snappafras Corp., Weston, MA (US)

(72) Inventors: Douglas P. Looze, Amherst, MA (US); Paul W. Kelley, Palm Coast, FL (US)

(21) Appl. No.: 14/699,105

(22) Filed: Apr. 29, 2015

Related U.S. Application Data
(60) Provisional application No. 62/060,868, filed on Oct. 7, 2014.

(51) Int. Cl. G01P 13/02; G01C 21/12

(52) U.S. Cl. CPC G01P 13/02; G01C 21/12

(57) ABSTRACT

A technique for automatically determining direction of motion of a pedestrian is described. In embodiments, accelerometer measurements obtained from an accelerometer of a mobile device are converted from a mobile device reference frame to a local level reference frame. The local level accelerometer measurements are filtered to obtain a first series of frequency components representing acceleration at an estimated stride frequency of the pedestrian in a first direction and a second series of frequency components representing acceleration at the estimated stride frequency of the pedestrian in a second direction that is orthogonal to the first direction. A heading angle of a major axis or semi-major axis of an ellipse defined at least by one or more frequency components in the first series and one or more frequency components in the second series is then determined The direction of motion of the pedestrian is determined based on the heading angle.

### CROSS-REFERENCE TO RELATED APPLICATIONS

This application claims priority to U.S. Provisional Patent Application No. 62/060,868, filed Oct. 7, 2014 and entitled “Location Determination System,” the entirety of which is incorporated by reference herein.

### BACKGROUND

Various systems and devices exist that can automatically determine a direction of motion of a mobile device and, by inference, of a person carrying the mobile device. For example, a GPS receiver in a mobile device can be used to determine a direction of motion of a user thereof by continuously tracking how the position of the mobile device changes over time. Though ubiquitous in mobile devices, GPS receivers consume a significant amount of the mobile device's precious battery life. Furthermore, information output by a GPS receiver can be rendered highly unreliable by multipath effects that occur when GPS satellite signals reflect off of structures or terrain that surround the GPS receiver. Areas that are known to generate severe multipath effects include urban canyons, mountainous areas, densely wooded areas, and indoor environments. Additionally, a GPS receiver may be rendered inoperable due to weather or the presence of large structures that completely block GPS satellite signals.

### SUMMARY

Systems, methods and computer program products are described herein that can automatically determine a direction of motion of a pedestrian. In accordance with certain embodiments, accelerometer measurements obtained from an accelerometer of a mobile device are converted from a mobile device reference frame to a local level reference frame. The local level accelerometer measurements are filtered to obtain a first series of frequency components representing acceleration at an estimated stride frequency of the pedestrian in a first direction and a second series of frequency components representing acceleration at the estimated stride frequency of the pedestrian in a second direction that is orthogonal to the first direction. A heading angle of a major axis or semi-major axis of an ellipse defined at least by one or more frequency components in the first series and one or more frequency components in the second series is then determined The direction of motion of the pedestrian is determined based on the heading angle.

In embodiments in which an initial position of the pedestrian has been determined or estimated, the direction of motion of the pedestrian can be combined with information such as an estimated number of steps taken by the pedestrian and an estimated stride length of the pedestrian to obtain an updated position of the pedestrian. By repeating this process, an ongoing position estimate of the pedestrian may be obtained.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the claimed subject matter is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the application and, together with the description, further serve to explain the principles of the embodiment and to enable a person skilled in the relevant art(s) to make and use the embodiments.

FIG. 1 is a block diagram of a mobile device that implements a method for automatically determining a direction of motion of a pedestrian in accordance with an embodiment.

FIG. 2 is a block diagram that shows various components of direction of motion determination logic in accordance with an embodiment.

FIG. 3 is a block diagram of the structure of an extended Kalman filter (EKF) that is used to estimate an attitude of a mobile device in accordance with an embodiment.

FIG. 4 depicts a flowchart of a processing order for an attitude estimation EKF that is used to estimate an attitude of a mobile device in accordance with an embodiment.

FIG. 5 is a graphical representation of Euler angles estimated by applying a direction of motion estimation algorithm in accordance with an embodiment to data generated by non-GPS navigational components.

FIG. 6 is a graphical representation of phase plots of north filtered acceleration vs. east filtered acceleration obtained in accordance with an embodiment. FIG. 6 also illustrates a best fit ellipse for the phase plots. A slope of a major axis of the best fit ellipse provides an estimated direction of motion of a pedestrian.

FIG. 7 is a graphical representation of direction of motion angles estimated by applying a direction of motion estimation algorithm in accordance with an embodiment to data generated by non-GPS navigational components.

FIG. 8 is a block diagram of the mobile device of FIG. 1 that illustrates that direction of motion estimation logic executed thereby may be included in a navigation application.

FIG. 9 is a block diagram of a client-server system that implements a method for automatically determining a direction of motion of a pedestrian in accordance with an embodiment.

FIG. 10 is a flowchart of a method for automatically determining a direction of motion of a pedestrian in accordance with an embodiment.

FIG. 11 is a block diagram of an example mobile device that may be used to implement various embodiments.

FIG. 12 is a block diagram of an example processor-based computer system that may be used to implement various embodiments.

The features and advantages of the embodiments described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of persons skilled in the relevant art(s) to implement such feature, structure, or characteristic in connection with other embodiments whether or not explicitly described.

Systems, methods and computer program products are described herein that can automatically determine a direction of motion of a pedestrian. As used herein, the term “pedestrian” is intended to broadly refer to a human or any other living creature that is travelling by means of their feet. The modes of travel encompassed by the term “pedestrian” may include but are not limited to walking, running, roller-skating, roller-blading, skateboarding, bicycling and the like.

In embodiments in which an initial position of the pedestrian has been determined or estimated, the direction of motion of the pedestrian can be combined with information such as an estimated number of steps taken by the pedestrian and an estimated stride length of the pedestrian to obtain an updated position of the pedestrian. By repeating this process, an ongoing position estimate of the pedestrian can be obtained.

As noted in the Background Section above, a conventional method for determining the direction of motion of a pedestrian involves continuous use of a GPS receiver included in a mobile device carried by the pedestrian. However, GPS receivers consume a significant amount of a mobile device's precious battery life. Furthermore, the accuracy of a GPS receiver may be impaired by multipath effects that arise when GPS satellite signals reflect off of structures or terrain that surround the GPS receiver. Additionally, a GPS receiver may be rendered inoperable due to weather or the presence of large structures that completely block GPS satellite signals.

Embodiments described herein are capable of determining a direction of motion of a pedestrian (e.g., determining a direction a pedestrian has walked or is walking) using only non-GPS navigational components included in an electronic device. The direction of motion can be utilized, for example, to determine a current position of the pedestrian. Thus, embodiments described herein can determine a direction of motion of a pedestrian as well as a position of a pedestrian in scenarios in which GPS does not work well or is unavailable. Embodiments described herein can also determine a direction of motion and a position of a pedestrian in a manner that consumes less mobile device power than GPS-based position tracking techniques.

In certain embodiments, determining the direction of motion of the pedestrian involves tracking the acceleration of a mobile device by obtaining acceleration measurements relative to a local level reference frame, generating an acceleration ellipse by analyzing frequency components of the local level acceleration measurements at an estimated stride frequency in both in a first direction (e.g., east) and in a second direction that is orthogonal to the first direction (e.g., north), wherein the acceleration ellipse represents both a side-to-side motion and a forward motion of the pedestrian, and determining the direction of motion of the pedestrian by determining a heading angle of a major axis or semi-major axis of the acceleration ellipse. In further accordance with such embodiments, the local level acceleration measurements may be obtained by first obtaining accelerometer measurements relative to a mobile device reference frame, by determining an estimated attitude of the mobile device, and then using the estimated attitude to rotate the accelerometer measurements from the mobile device reference frame to the local level reference frame.

In the following sections, embodiments of the aforementioned systems, methods and computer program products will be more fully described. In particular, Section II describes systems, methods and computer program products that automatically determine a direction of motion of a pedestrian. Section III describes an example mobile device that may be used to implement various embodiments. Section IV described an example processor-based computer system that may be used to implement various embodiments. Section V provides some concluding remarks.

II. Systems, Methods and Computer Program Products that Automatically Determine a Direction of Motion of a Pedestrian

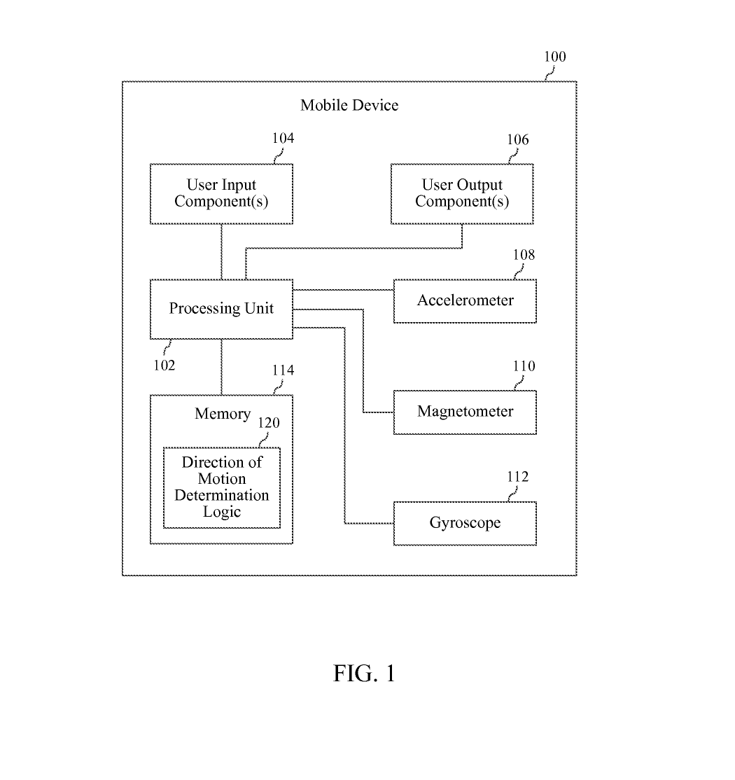

FIG. 1 is a block diagram of a mobile device 100 that implements a method for automatically determining a direction of motion of a pedestrian in accordance with an embodiment. Mobile device 100 may comprise any of a wide variety of portable electronic devices including but not limited to a smart phone, a tablet computer, a laptop computer, a wearable computing device, a wearable fitness device, a pedometer, a personal media player, or the like. Mobile device 100 is presented herein by way of example only. Based on the teachings provided herein, persons skilled in the relevant art(s) will appreciate that the method for automatically determining a direction of motion of a pedestrian can be implemented by other devices and systems as well.

As shown in FIG. 1, mobile device 100 includes a processing unit 102. Processing unit 102 comprises a central processing unit (CPU), a microprocessor, a multi-core processor, or other integrated circuit that is configured to execute computer program instructions that are retrieved from memory (e.g., memory 114), thereby causing certain operations to be performed. As further shown in FIG. 1, processing unit is connected to one or more user input components 104, one or more user output component 106, an accelerometer 108, a magnetometer 110, a gyroscope 112, and a memory 114.

User input component(s) 104 may comprise one or more of a touch screen, keypad, button, microphone, camera, or other component suitable for enabling a user to provide input to mobile device 100. User output component(s) 104 may comprise one or more of a display, audio speaker, haptic feedback element, or other component suitable for providing output to a user of mobile device 100.

Accelerometer 108 comprises an electromechanical component that is configured to measure acceleration forces. In an embodiment, accelerometer 108 comprises a 3-axis accelerometer that is configured to measure acceleration along each of three orthogonal axes of a right-handed mobile device reference frame. The three axes may be denoted the x-axis, the y-axis, and the z-axis. In an embodiment in which mobile device 100 comprises a mobile phone having a generally rectangular display on one side thereof, the x-axis may run along the short side of the display, the y-axis may run along the long side of the display, and the z-axis may run perpendicular to and out of the front of the display. However, other mobile device reference frames may be used. Each acceleration measurement may be represented in meters per second squared (m/s²) or other suitable unit of measurement.

Magnetometer 110 comprises a measurement instrument that is configured to measure the strength of the Earth's magnetic field. In an embodiment, magnetometer 110 comprises a 3-axis magnetometer that is configured to measure the strength of the Earth's magnetic field along each of the axes of the aforementioned mobile device reference frame. Each magnetometer measurement may be represented in Webers per second squared (Wb/s²) or other suitable unit of measurement.

Gyroscope 112 comprises a measurement instrument that measures orientation of mobile device 100. In an embodiment, gyroscope 112 comprises a 3-axis MEMS gyroscope that is configured to measure a rate of rotation around each of the axes of the aforementioned mobile device reference frame. Each gyroscope measurement may be represented in radians per second (rad/s) or other suitable unit of measurement.

Memory 114 comprises one or more volatile or non-volatile memory devices that are operable to store computer program instructions (also referred to herein as computer program logic). These computer program instructions may be retrieved from memory 114 and executed by processing unit 102 in a well-known manner to cause processing unit 102 to perform certain operations.

As further shown in FIG. 1, memory 114 stores direction of motion determination logic 120. Direction of motion determination logic 120 comprises computer program instructions that, when executed by processing unit 102, causes processing unit 102 to perform an algorithm for determining the direction of motion of a pedestrian. As will be described below, this algorithm uses as input measurement data from each of accelerometer 108, magnetometer 110 and gyroscope 112, and outputs a current direction of motion.

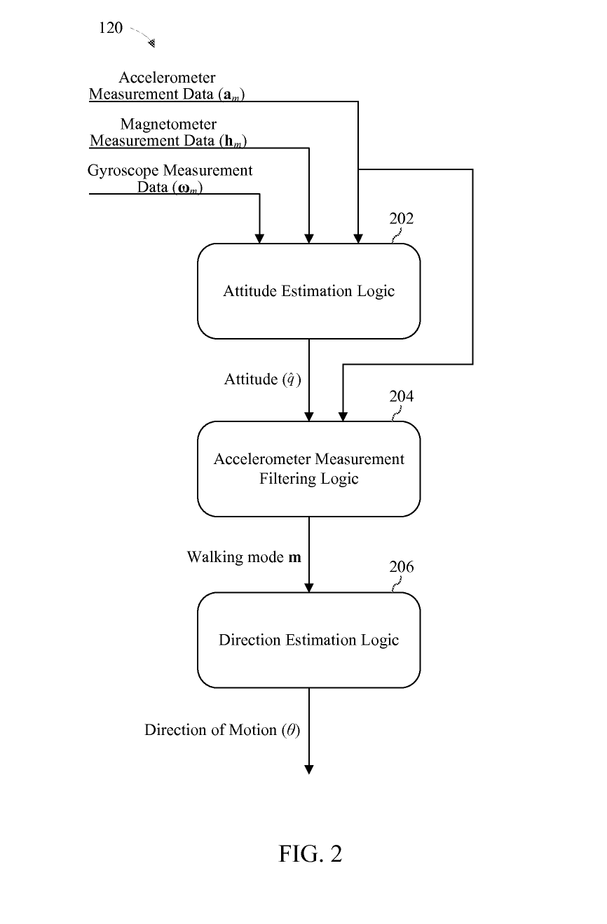

FIG. 2 is a block diagram that shows various components of direction of motion determination logic 120 in accordance with an embodiment. As shown in FIG. 2, direction of motion determination logic 120 includes attitude estimation logic 202, accelerometer measurement filtering logic 204, and direction estimation logic 206. Each of these components will now be briefly described, with additional details to be provided in subsequent sub-sections.

Attitude estimation logic 202 is configured to receive as input measurement data from accelerometer 108 (denoted aₘ), measurement data from magnetometer 110 (denoted hₘ), and measurement data from gyroscope 112 (denoted ωₘ). Such measurement data may be provided intermittently or periodically from each of these sensors, and at different times. Each instance of measurement data received from accelerator 108 comprises an acceleration measurement along the x-axis, y-axis and z-axis of the aforementioned mobile device reference frame. Each instance of measurement data received from magnetometer 110 comprises a magnetometer measurement along the x-axis, y-axis and z-axis of the aforementioned mobile device reference frame. Each instance of measurement data received from gyroscope 112 comprises a measure of the rate of rotation around each of the x-axis, y-axis and z-axis of the aforementioned mobile device reference frame.

Attitude estimation logic 202 uses these inputs to intermittently or periodically estimate a current attitude or orientation of mobile device 100, denoted \hat{q}. The estimated attitude of mobile device 100 represents an estimate of the rotation required to translate an acceleration measurement in the mobile device reference frame to an acceleration measurement in a local level reference frame. The local level reference frame is a right-handed reference frame that is centered on mobile device 100. The x-axis points to the geographic magnetic east, the y-axis points to the geographic magnetic north, and the z-axis points up, away from the center of the earth.

Additional details concerning specific example implementations of attitude estimation logic 202 will be presented in Section II.A, below.

Accelerometer measurement filtering logic 204 is operable to intermittently or periodically receive accelerometer measurement data aₘ from accelerometer 108 and the estimated orientation \hat{q} from attitude estimation logic. Acceleration measurement filtering logic 204 rotates the accelerometer measurement data aₘ using the estimated orientation \hat{q}, to obtain accelerometer measurements in the local level reference frame. In this way, the direction of motion of the pedestrian can be determined in reference to the local level reference frame.

Furthermore, accelerometer measurement filtering logic 204 filters series of accelerometer measurements in the local level reference frame to obtain a first series of frequency components representing acceleration in a first direction (e.g., east) at an estimated stride frequency of a pedestrian and a second series of frequency components representing acceleration in a second direction that is orthogonal to the first direction (e.g., north) at the estimated stride frequency of the pedestrian. These frequency components may be denoted the walking mode, m, of the pedestrian.

Additional details concerning specific example implementations of accelerometer measurement filtering logic 204 will be presented in Section II.B, below.

Direction estimation logic 206 is operable to intermittently or periodically receive the walking mode, m, from accelerometer measurement filtering logic 204, which as noted above includes the first series of frequency components and the second series of frequency components. Direction estimation logic 206 determines a heading angle of a major or semi-major axis of an ellipse defined by at least one or more frequency components in the first series of frequency components and one or more frequency components in the second series of frequency components. Direction estimation logic 206 then determines or estimates a direction of motion of the pedestrian, denoted θ, based on the heading angle.

Additional details concerning specific example implementations of direction estimation logic 206 will be presented in Section II.C, below.

The estimated direction of motion generated by direction of motion determination logic 120 may be utilized for a variety of purposes by a variety of software programs (e.g., one or more software applications executing on mobile device 100). For example, the direction of motion estimate can be combined with stride-length and number-of-steps estimates to provide an ongoing position estimate. The position estimate can be further enhanced by augmenting it with other sensor data (such as GPS or Wi-Fi) when available. Such position estimate may be presented to a user of mobile device 100 via one or more of user output component(s) 106. For example, the position estimate may be presented to the user via a graphical user interface (GUI) rendered to a display of mobile device 100. Further details concerning exemplary applications of direction of motion determination logic 120 will be described below in Section II.D.

### II.A Attitude Estimation Logic 202

As noted above, the direction of motion of the pedestrian should be specified relative to the local geography. However, the measurements generated by the sensors within mobile device 100 (i.e., accelerometer 108, magnetometer 110 and gyroscope 112) are made relative to mobile device 100 itself. The orientation of mobile device 100 is continually changing relative to the local geography. In an embodiment that will be described in this sub-section, attitude estimation logic 202 utilizes a Lefferts-Markley-Shuster (LMS) extended Kalman filter (EKF) to estimate the attitude or orientation of the phone. The estimated attitude is then used by accelerometer measurement filtering logic 204 to rotate the accelerometer measurement to be relative to the local geometry. It is noted that other methods may also be used to estimate the attitude of mobile device 100.

The state and structure of the attitude estimation EKF is described below. In particular, the different characteristics of the accelerometer and magnetometer measurements result in a decomposition of the update algorithm. The measurement models for the accelerometer, magnetometer, and gyroscope are presented below. The EKF state propagation is described below. The two algorithms that are used to update the EKF with the accelerometer and magnetometer measurements are described below as well.

II.A.1. Estimation State and Structure of the Attitude Estimation EKF

II.A.1.1. Reference Frames

In an embodiment, two right-handed reference frames are used. These reference frames include a mobile device reference frame, which is also referred to herein as the body reference frame (denoted by superscript b), and a local level reference frame. In one embodiment in which mobile device 100 comprises a mobile phone having a generally rectangular display on one side thereof, the body frame has an x-axis along the short side of the display, a y-axis along the long side of the display, and a z-axis perpendicular to and out of the front of the display.

The second set of coordinates, the local level reference frame (denoted by a superscript l), is centered on mobile device 100. The x-axis of the local level reference frame points to the geographic magnetic east, the y-axis of the local level reference frame points to the geographic magnetic north, and the z-axis of the local level reference frame points up, away from the center of the earth. It is noted that this frame differs from the usual aerospace frame (i.e., x-axis north, y-axis east and z-axis down). Gravity removal and translation calculations are carried out in this frame.

The rotation of vectors from the local level reference frame to the body reference frame is represented by the unit quaternion q, where q is a 4-dimensional vector:

$$\begin{matrix}q = [ \begin{matrix}\underline{{q}_{0}} \\ {q}_{1} \\ {q}_{2} \\ {q}_{3}\end{matrix} ] = [ \begin{matrix}{q}_{0} \\ q\end{matrix} ] \\ such that \text{:} & ( 1 ) \\ {q}_{0}^{2} + {q}_{1}^{2} + {q}_{2}^{2} + {q}_{3}^{2} = 1 & ( 2 )\end{matrix}$$

This rotation can equivalently be characterized by the rotation matrix R(q):

$$R ( q ) = [ \begin{matrix}{r}_{1} ( q ) & {r}_{2} ( q ) & {r}_{3} ( q )\end{matrix} ] = [ \begin{matrix}2 {q}_{0}^{2} - 1 + 2 {q}_{1}^{2} & 2 ( {q}_{1} {q}_{2} + {q}_{0} {q}_{3} ) & 2 ( {q}_{1} {q}_{3} - {q}_{0} {q}_{2} ) \\ 2 ( {q}_{1} {q}_{2} - {q}_{0} {q}_{3} ) & 2 {q}_{0}^{2} - 1 + 2 {q}_{2}^{2} & 2 ( {q}_{3} {q}_{2} + {q}_{0} {q}_{1} ) \\ 2 ( {q}_{1} {q}_{3} + {q}_{0} {q}_{2} ) & 2 ( {q}_{3} {q}_{2} - {q}_{0} {q}_{1} ) & 2 {q}_{0}^{2} - 1 + 2 {q}_{3}^{2}\end{matrix} ] \qquad ( 3 )$$

Thus, if v is a vector in the local level reference frame, in the body reference frame it is:

w=q* [symbol] v [symbol] q=R(q)v (4)

where [symbol] denotes quaternion multiplication and where q* represents the conjugation of q.

Let ω(t) be the instantaneous rate of rotation about the three axes of the body reference frame. In continuous time, the dynamic evolution of the quaternion representing the attitude of mobile device 100 is given by:

$$\dot{q} ( t ) = \frac{1}{2} Ω ( ω ( t ) ) \hat{ω} Ω ( ω ) = [ \begin{matrix}0 & - {ω}_{1} & - {ω}_{2} & - {ω}_{3} \\ {ω}_{1} & 0 & {ω}_{3} & - {ω}_{2} \\ {ω}_{2} & - {ω}_{3} & 0 & {ω}_{1} \\ {ω}_{3} & {ω}_{2} & - {ω}_{1} & 0\end{matrix} ] \qquad ( 5 )$$

II.A.1.2. Estimation State

The attitude estimation EKF uses measurements from accelerometer 108, magnetometer 110, and gyroscope 112 to determine an estimate of the attitude of mobile device 100 using an LMS EKF. The attitude of mobile device 100 is represented by a rotation from the local level coordinate system to the body coordinate system. The full rotation is in turn represented by a unit quaternion q. The LMS EKF represents the quaternion estimation error δ\tilde{q} as the quaternion that must be composed with the estimated quaternion \hat{q} to obtain the true quaternion q:

\hat{q} [symbol] δ\tilde{q}=q [symbol] δ\tilde{q}=\hat{q}⁻¹ [symbol] q (6)

That is, the true rotation is the rotation defined by the error quaternion composed with the estimated rotation:

R(q)=R(δ\tilde{q})R(\hat{q}) (7)

The error quaternion is assumed small, and can therefore be approximated by

$$δ \tilde{q} = [ \begin{matrix}1 \\ δ q\end{matrix} ] = [ \begin{matrix}1 \\ δ {q}_{x} \\ δ {q}_{y} \\ δ {q}_{z}\end{matrix} ] \qquad ( 8 )$$

The total LMS EKF state includes the estimated quaternion and the 3-dimensional gyroscope bias estimate \hat{ω}_{b}:

$$\hat{x} = [ \begin{matrix}\hat{q} \\ {\hat{ω}}_{b}\end{matrix} ] \qquad ( 9 )$$

The estimation error is expressed in terms of the three non-unity states of the error quaternion δ\hat{q} (the vector components) and the 3-dimensional gyroscope bias estimation error:

$$Δ {x}_{e} = [ \begin{matrix}δ \hat{q} \\ {\hat{ω}}_{b} - {ω}_{b}\end{matrix} ] \qquad ( 10 )$$

The estimation error covariance is:

P=E{ΔxₑΔxₑ^{T}} (11)

II.A.1.3. EKF Structure

Many attitude estimation techniques (including the TRIAD algorithm available on GOOGLE™ ANDROID® phones and standard EKF procedures) use both the accelerometer and magnetometer measurements simultaneously. However, the magnetometer measurement suffers from large uncertainties in the inclination and magnitude relative to the gravity vector. To address this issue, the present embodiment exploits a decomposition of process for updating the EKF into an accelerometer EKF update and a magnetometer EKF update. The estimate of the local level reference plane is determined from the accelerometer and gyroscope measurements. The magnetometer measurement (almost exclusively) determines the heading (orientation) within that plane.

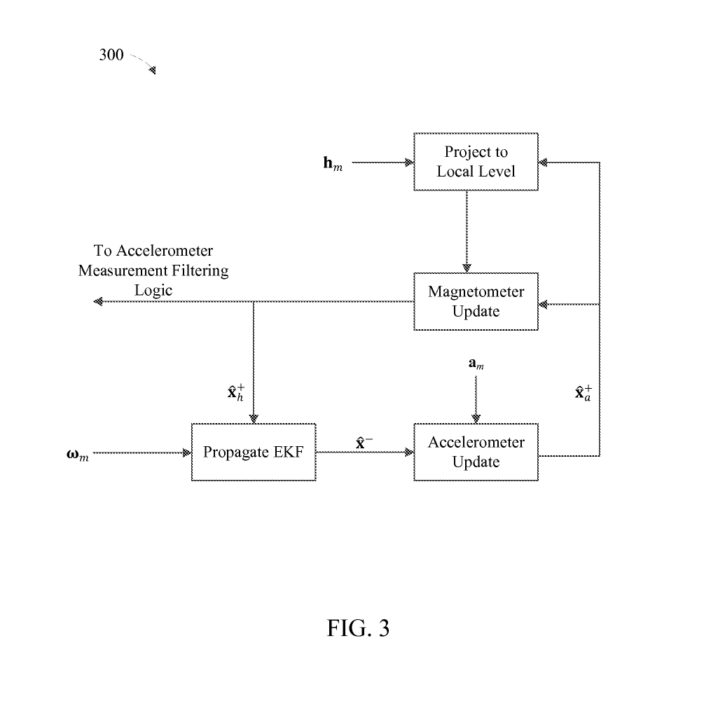

Thus, the accelerometer EKF update provides a correction to the estimate of the quaternion along the gravity vector. The magnetometer EKF update uses the magnetometer measurement to estimate the local level heading (i.e., the rotation of mobile device 100 around the gravity vector). A block diagram of the resulting EKF structure 300 is shown in FIG. 3.

It is assumed that measurement events involving accelerometer 108, magnetometer 110, and gyroscope 112 are provided at times tₖ:k=0,1, . . . . Only one type of measurement occurs at each event time tₖ. If two or more measurements are simultaneous (e.g., accelerometer and magnetometer measurements occur at the same time), each is assigned a separate event time with tₖ=tₖ₊₁. The time increment between events is defined as

Tₖ=tₖ₊₁−tₖ (12)

II.A.1.4. Initialization

The state estimate and error covariance must be initialized when the EKF is started. If accelerometer and magnetometer measurements are available, the initial rotation estimate is computed using innate software available on mobile device 100 (such as the TRIAD algorithm available on GOOGLE™ ANDROID® phones). Otherwise, the initial attitude will be:

$${\hat{q}}_{0}^{+} = \frac{1}{\sqrt{2}} [ \begin{matrix}1 \\ 1 \\ 0 \\ 0\end{matrix} ] \qquad ( 13 )$$

The initial gyroscope bias estimates will be the values from the last time the attitude estimation algorithm was executed. If no estimates were saved, the initial gyroscope bias estimates will be set to zero:

\hat{ω}_{b,0}=0 (14)

In the worst case, the initial covariance of the vector components of the error quaternion are each uniformly distributed in the interval −1≦qᵢ≦1, i=x, y, z. This uncertainty is zero-mean with variance ⅓. Thus, the initial error covariance will be:

P₀⁺=1/3I (15)

where I is the 3×3 identity matrix. The initial gyroscope bias error covariances will be zero.

II.A.2. Measurement Models

II.A.2.1. Gyroscope Measurement

The gyroscope measurement ω_{m,k} available at time tₖ is a discrete-time measurement of the rate of rotation about the three body axes ωₖ:

ω_{m,k}=ω(tₖ)+ω_{b,k}+v_{ω,k} (16)

where v_{m,k} is a stationary, zero mean, white noise measurement error with covariance V_{ω} and ω_{b} is a small bias. If the initial attitude of mobile device 100 is known, and both ω_{b} and V_{ω} were zero, the attitude at any later time could be determined by integrating the gyroscope measurement. However, the measurement is corrupted by a small white noise error and bias that causes a slow drift in the computed attitude. Consequently, an attitude estimate can use the gyroscope measurement for short times, but must augment the gyroscope with additional measurements.

The gyroscope bias is modeled as a discrete time random walk:

ω_{b,k+1}=ω_{b,k}+v_{b,k} (17)

where v_{b,k} is a stationary, zero mean, white noise measurement error with covariance V_{b}.

II.A.2.2. Accelerometer Measurement

The attitude estimation algorithm uses the acceleration measurement to provide an absolute, known direction—gravity g. The gravity vector direction in the local level reference frame lies along the z-axis:

$$g = [ \begin{matrix}0 \\ 0 \\ - g\end{matrix} ] \qquad ( 18 )$$

where g is the magnitude of the gravity vector (ideally, g=9.8 [symbol] g₀).

The three-dimensional accelerometer measurement at time tₖ is a discrete-time measurement of a linear combination of gravity g rotated to the body frame, linear acceleration (the acceleration of the phone relative to stationary objects) rotated to the body frame, and a (small) constant bias. The filter is designed so that linear acceleration and biases can be neglected. Thus, the accelerometer measurement model is:

a_{m,k}=−R(qₖ)g+v_{a,k} (19)

where v_{α} is a zero mean white noise error with covariance Vₐ.

II.A.2.3. Magnetometer Measurement

Ideally, the magnetometer measurement at time tₖ is a discrete-time estimate of the magnetic field h rotated to the body frame plus a (small) bias h_{b}:

h_{m,k}=R(qₖ)h+h_{b}+ v̅_{h,k} (20)

where is v̅_{h,k} is a zero mean, white noise process with covariance V̅ₕ. The magnetic field vector at a given latitude Φ and longitude Λ is aligned relative to true north at a declination angle Dₕ and an at inclination angle Iₕ relative to the local level:

$$h = H [ \begin{matrix}sin {D}_{h} cos {I}_{h} \\ cos {D}_{h} cos {I}_{h} \\ - sin {I}_{h}\end{matrix} ] \qquad ( 21 )$$

The attitude estimation algorithm uses the magnetometer measurement to provide an absolute, known direction—the magnetic field vector h. Except at the magnetic poles, this will be linearly independent of the gravity vector. Thus, the accelerometer and magnetometer measurement can be used for a well-posed estimation of the attitude of mobile device 100. However, the magnetometer covariance Vₕ is generally much larger than the accelerometer covariance Vₐ. The projection of the magnetometer measurement perpendicular to the gravity measurement is characterized by rotation around the gravity vector, and the first two components of (21). In this plane, the magnetometer bias will be neglected. The model for the projected magnetometer measurement is:

$${\tilde{h}}_{rm , k} = \overline{H} [ \begin{matrix}sin {D}_{h} \\ cos {D}_{h}\end{matrix} ] \overline{H} = H cos {I}_{h} \qquad ( 22 )$$

II.A.3. EKF Propagation

II.A.3.1 Quaternion

When an event occurs at tₖ₊₁, the estimate is first updated to time tₖ₊₁ using the quaternion dynamic model (5) and the gyroscope bias random walk model (17). If the events correspond to the availability of new accelerometer or magnetometer measurement, the new measurement is incorporated via the update procedures described below.

Assuming the update interval Tₖ is small, the expected value of the rotation rate is approximately constant and is given by:

ω(t)≈ω_{m,k}−\hat{ω}_{b,k}⁺ [symbol] \hat{ω}ₖ tₖ≦t≦tₖ₊₁ (23)

where ω_{m,k} is the most recent gyroscope measurement and \hat{ω}_{b,k}⁺ is the most recent estimate of the gyroscope bias. Then, the quaternion is updated by:

$${\tilde{q}}_{k + 1}^{-} = ( I + \frac{{T}_{k}}{2} Ω ( {\hat{ω}}_{k} ) ) {\hat{q}}_{k}^{+} \qquad ( 24 )$$

The propagation (24) does not guarantee that \tilde{q}ₖ₊₁⁻ will be a unit quaternion. It is restored to a unit quaternion by dividing by the norm of the computed quaternion:

$${\hat{q}}_{k + 1}^{-} = \frac{1}{‖ {\tilde{q}}_{k + 1}^{-} ‖} {\tilde{q}}_{k + 1}^{-} \qquad ( 25 )$$

II.A.3.2 Gyroscope Bias

The gyroscope bias states remain unchanged during propagation:

\hat{ω}_{b,k+1}⁻=\hat{ω}_{b,k}⁺ (26)

II.A.3.3 Summary

The propagated full state estimate is:

$${\hat{x}}_{k + 1}^{-} = [ \begin{matrix}{\hat{q}}_{k + 1}^{-} \\ {\hat{ω}}_{k + 1}^{-}\end{matrix} ] \qquad ( 27 )$$

Let the error covariance (see (11)) at time tₖ prior to any updates be denoted by Pₖ⁻, and after an update by Pₖ⁺. The error covariance propagation is::

Pₖ₊₁⁻=FₖPₖ⁺Fₖ^{T}+Xₖ (28)

where the matrices Fₖ and Xₖ are the discrete time equivalents of the continuous time matrices given in E. J. Lefferts, F. L. Markley, and M. D. Shuster, “Kalman Filtering for Spacecraft Attitude Estimation,” J. Guidance, control, and dynamics, 5, Sep.-Oct. 1982, p. 417-429, the entirety of which is incorporated by reference herein. Define

$${Ω}_{r} ( ω ) = [ \begin{matrix}0 & - {ω}_{3} & {ω}_{2} \\ {ω}_{3} & 0 & - {ω}_{1} \\ - {ω}_{2} & {ω}_{1} & 0\end{matrix} ] \qquad ( 29 )$$

If ∥\hat{ω}ₖ∥ is non-zero, the system matrix Fₖ is:

$${F}_{k} [ \begin{matrix}{L}_{k} & {K}_{k} \\ 0 & I\end{matrix} ] \\ {L}_{k} = I - {Ω}_{r}^{2} ( {\hat{ω}}_{k} ) \frac{cos ‖ {\hat{ω}}_{k} ‖ - 1}{{‖ {\hat{ω}}_{k} ‖}^{2}} + {Ω}_{r} ( {\hat{ω}}_{k} ) \frac{sin ‖ {\hat{ω}}_{k} ‖}{‖ {\hat{ω}}_{k} ‖} \\ {K}_{k} = \frac{1}{2} ( - {T}_{k} I - {Ω}_{r}^{2} ( {\hat{ω}}_{k} ) ( \frac{{T}_{k}}{{‖ {\hat{ω}}_{k} ‖}^{2}} - \frac{sin ‖ {\hat{ω}}_{k} ‖}{{‖ {\hat{ω}}_{k} ‖}^{3}} ) + {Ω}_{r} ( {\hat{ω}}_{k} ) \frac{cos ‖ {\hat{ω}}_{k} ‖ - 1}{{‖ {\hat{ω}}_{k} ‖}^{2}} ) \qquad ( 30 )$$

### Otherwise:

$${F}_{k} = [ \begin{matrix}I & - \frac{{T}_{k}}{2} I \\ 0 & I\end{matrix} ] \qquad ( 31 )$$

The process noise covariance Xₖ is approximated as:

$${X}_{k} = [ \begin{matrix}\frac{{T}_{k}}{4} {V}_{ω} + \frac{{T}_{k}^{3}}{12} {V}_{b} & \frac{{T}_{k}^{2}}{4} {V}_{b} \\ \frac{{T}_{k}^{2}}{4} {V}_{b} & {T}_{k} {V}_{b}\end{matrix} ] \qquad ( 32 )$$

II.A.4. EKF Measurement Updates

II.A.4.1 Accelerometer Measurement Update

When an accelerometer measurement a_{m,k} becomes available at time tₖ, the most recent estimate \hat{x}ₖ₋₁⁺ and the error covariance Pₖ₋₁⁺ are propagated using the procedure described below to obtain the propagated attitude estimate \hat{x}ₖ⁻ and propagated error covariance Pₖ⁻. Since there is no gyroscope measurement at time tₖ, the gyroscope measurement is taken to be the most recent gyroscope measurement:

ω_{m,k}=ω_{m,k-1} (33)

The accelerometer measurement is first normalized by dividing it by the nominal gravity g₀=9.8 m/s²:

$${a}_{n , k} = \frac{1}{{g}_{0}} {a}_{m , k} \qquad ( 34 )$$

The estimated normalized accelerometer measurement is third column of the estimated rotation:

â_{n,k}=r₃(\hat{q}ₖ⁻) (35)

The EKF update increment is:

Δ\hat{x}_{a,k}=K_{a,k}(a_{n,k}−â_{n,k}) (36)

where K_{a,k} is the Kalman gain. The Kalman gain K_{a,k} is computed from the propagated error covariance Pₖ⁻ using the linearized measurement matrix of the error states:

Hₐ(\hat{q}ₖ⁻)=[2Ωᵣ(\hat{q}ₖ⁻) 0] (37)

The Kalman gain is computed as:

$${K}_{a , k} = {P}_{k}^{-} {{H}_{a} ( {\hat{q}}_{k}^{-} )}^{T} {( {H}_{a} ( {\hat{q}}_{k}^{-} ) {P}_{k}^{-} {{H}_{a} ( {\hat{q}}_{k}^{-} )}^{T} + \frac{1}{{g}_{0}^{2}} {V}_{a} )}^{- 1} \qquad ( 38 )$$

The error covariance is also updated using the Kalman gain:

Pₖ⁺=(I−Hₐ(\hat{q}ₖ⁻)K_{a,k})Pₖ⁻ (39)

The estimate is updated using the estimate increment. The estimate increment can be partitioned into two three-dimensional increments:

$$Δ {\hat{x}}_{a , k} = [ \begin{matrix}δ {\hat{q}}_{a , k} \\ δ {\hat{ω}}_{a , k}\end{matrix} ] \qquad ( 40 )$$

where δ\hat{q}_{a,k} is the incremental update for the vector component of the error quaternion, and δ\hat{ω}_{a,k} is the incremental update of the bias estimate. The updated estimate of the quaternion representing the overall rotation is:

$$\begin{matrix}{\tilde{q}}_{k}^{+} = {\hat{q}}_{k}^{-} + Ξ ( {\hat{q}}_{k}^{-} ) δ {\hat{q}}_{a , k} & ( 41 ) \\ where & \\ Ξ ( q ) = [ \begin{matrix}- {q}_{1} & - {q}_{2} & - {q}_{3} \\ {q}_{0} & - {q}_{3} & {q}_{2} \\ {q}_{3} & {q}_{0} & - {q}_{1} \\ - {q}_{2} & {q}_{1} & {q}_{0}\end{matrix} ] & ( 42 )\end{matrix}$$

As with the propagation, the quaternion estimate that results from the update (41) may not be a unit quaternion. It is restored to a unit quaternion by dividing by the norm of the computed quaternion:

$${\hat{q}}_{k}^{+} = \frac{1}{‖ {\tilde{q}}_{k}^{+} ‖} {\tilde{q}}_{k}^{+} \qquad ( 43 )$$

The updated full state estimate is then:

$${\hat{x}}_{k}^{+} = [ \begin{matrix}{\hat{q}}_{k}^{+} \\ {\hat{ω}}_{k}^{-} + δ {\hat{ω}}_{a , k}\end{matrix} ] \qquad ( 44 )$$

II.A.4.2 Magnetometer Measurement Update

When a magnetometer measurement h_{m,k} becomes available at time tₖ, the most recent estimate \hat{x}ₖ₋₁⁺ and the error covariance Pₖ₋₁⁺ are propagated using the procedure above to obtain the propagated attitude estimate \hat{x}ₖ⁻ and propagated error covariance Pₖ⁻. Since there is no gyroscope measurement at time tₖ, the gyroscope measurement is taken to be the most recent body rate measurement:

ω_{m,k}=ω_{m,k-1} (45)

Although the magnetometer measurement could be used to update the full EKF estimate (as with the accelerometer measurement), the significantly greater uncertainty of the magnetometer measurement results in the magnetometer measurement being used solely to estimate the heading angle. This procedure results in a simplification of the update.

The magnetometer measurement h_{m,k} is projected orthogonally to the estimated vertical:

h_{p,k}=h_{m,k}−r₃(\hat{q}ₖ⁻)r₃^{T}(\hat{q}ₖ⁻)h_{m,k} (46)

The projected magnetometer measurement (46) is then normalized:

$${h}_{n , k} = \frac{1}{‖ {h}_{p , k} ‖} {h}_{p , k} \qquad ( 47 )$$

The estimated normalized magnetometer measurement is just the second column of the estimated rotation:

ĥ_{n,k}=r₂(\hat{q}ₖ⁻) (48)

The EKF update increment is:

Δ\hat{x}_{m,k}=K_{m,k}(h_{n,k}−ĥ_{n,k}) (49)

where K_{m,k} is the Kalman gain. The Kalman gain K_{m,k} is computed from the propagated error covariance Pₖ⁻ using the linearized measurement matrix of the error states:

Hₘ(\hat{q}ₖ⁻)=[2Ωᵣ(\hat{q}ₖ⁻) 0] (50)

The Kalman gain is computed as:

$${K}_{m , k} = {P}_{k}^{-} {{H}_{m} ( {\hat{q}}_{k}^{-} )}^{T} {( {H}_{m} ( {\hat{q}}_{k}^{-} ) {P}_{k}^{-} {{H}_{m} ( {\hat{q}}_{k}^{-} )}^{T} + \frac{1}{{‖ {h}_{p , k} ‖}^{2}} {V}_{m} )}^{- 1} \qquad ( 51 )$$

The error covariance is also updated using the Kalman gain:

Pₖ⁺=(I−Hₘ(\hat{q}ₖ⁻)K_{a,k})Pₖ⁻ (52)

The estimate is updated using the estimate increment. The estimate increment can be partitioned into two three-dimensional increments:

$$Δ {\hat{x}}_{m , k} = [ \begin{matrix}δ {\hat{q}}_{m , k} \\ δ {\hat{ω}}_{m , k}\end{matrix} ] \qquad ( 53 )$$

where δ\hat{q}_{m,k} is the incremental update for the vector component of the error quaternion and δ\hat{ω}_{m,k} is the incremental update of the bias estimate. The updated estimate of the quaternion representing the overall rotation is:

\tilde{q}ₖ⁺=\hat{q}ₖ⁻+Ξ(\hat{q}ₖ⁻)δ\hat{q}_{m,k} (54)

Again, the quaternion estimate that results from the update (54) may not be a unit quaternion. It is restored to a unit quaternion by dividing by the norm of the computed quaternion:

$${\hat{q}}_{k}^{+} = \frac{1}{‖ {\tilde{q}}_{k}^{+} ‖} {\tilde{q}}_{k}^{+} \qquad ( 55 )$$

The updated full state estimate is then:

$${\hat{x}}_{k}^{+} = [ \begin{matrix}{\hat{q}}_{k}^{+} \\ {\hat{ω}}_{k}^{-} + δ {\hat{ω}}_{m , k}\end{matrix} ] \qquad ( 56 )$$

II.A.5 Processing Order Depiction

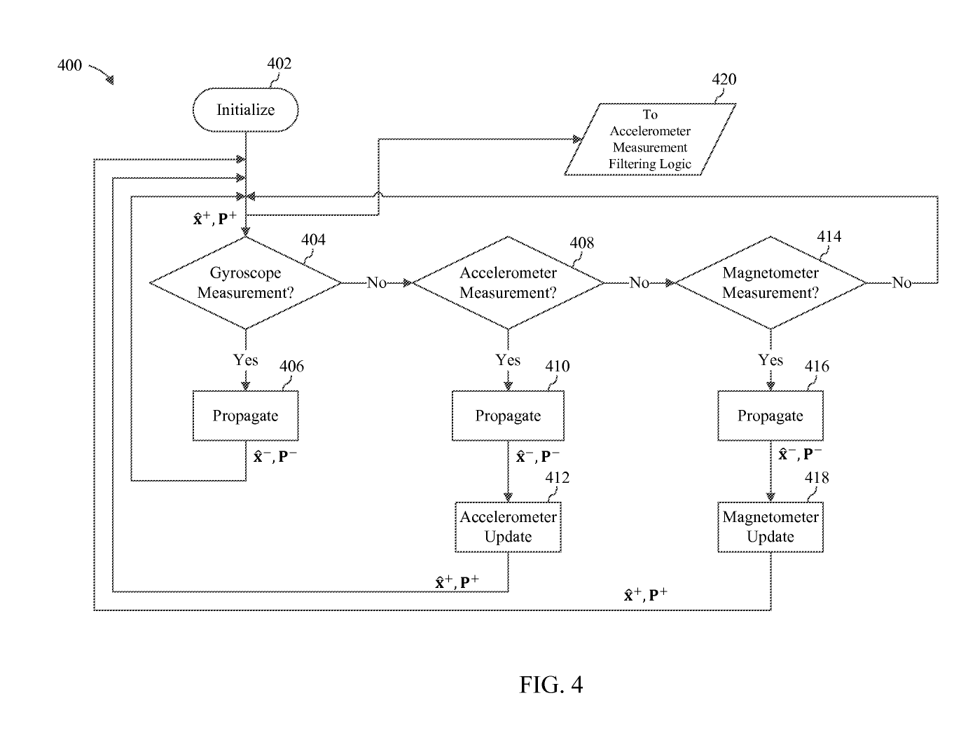

FIG. 4 is a flowchart 400 that depicts the processing order for the above-described attitude estimation EKF. As shown in FIG. 4, the process of flowchart 400 begins with initialization at step 402, after which an initial state estimate and error covariance is provided to accelerometer measurement filtering logic 204 as shown at step 420. The manner in which initialization is carried out is described above in Section II.A.1.4.

After this, control flows to decision step 404, during which it is determined whether a new gyroscope measurement has been received. If a new gyroscope measurement has been received, then EKF propagation is carried out in the manner described above in Section II.A.3 as shown at step 406, the current state estimate and error covariance is provided to accelerometer measurement filtering logic 204 as shown at step 420, and control returns to decision step 404.

If it is determined during decision step 404 that a new gyroscope measurement has not been received, then control flows to decision step 406, during which it is determined whether a new accelerometer measurement has been received. If a new accelerometer measurement has been received, then EKF propagation is carried out in the manner described above in Section II.A.3 as shown at step 410, after which an accelerometer measurement update is carried out in the manner described above in Section II.A.4.1 as shown at step 412. The current state estimate and error covariance is then provided to accelerometer measurement filtering logic 204 as shown at step 420, and control returns to decision step 404.

If it is determined during decision step 408 that a new accelerometer measurement has not been received, then control flows to decision step 414, during which it is determined whether a new magnetometer measurement has been received. If a new magnetometer measurement has been received, then EKF propagation is carried out in the manner described above in Section II.A.3 as shown at step 416, after which a magnetometer measurement update is carried out in the manner described above in Section II.A.4.2 as shown at step 418. The current state estimate and error covariance is then provided to accelerometer measurement filtering logic 204 as shown at step 420, and control returns to decision step 404.

II.B Acceleration Measurement Filtering Logic 204

As discussed above, in an embodiment, attitude estimation logic 202 is configured to compute the quaternion representing the overall rotation of mobile device 100 from the body reference frame to the local level reference frame. The fundamental mode in the accelerometer measurement in the direction of walking has the same frequency as the stride frequency fₛ. At this frequency is also a second harmonic of an acceleration orthogonal to the direction of walking. The acceleration modes at the stride frequency can be used to estimate the walking direction. When an accelerometer measurement a_{m,k} in the body reference frame becomes available at time tₖ, attitude estimation logic 202 propagates the state estimate to time tₖ and updates the state estimate using the accelerometer measurement (as described above) to obtain the current best estimate of the quaternion \hat{q}ₖ⁺. It is noted that methods other than quaternions can be used to find the local level plane.

In an embodiment, accelerometer measurement filtering logic 204 is configured to rotate the accelerometer measurements to the local level reference frame using the quaternion. Accelerometer measurement filtering logic 204 may rotate the accelerometer measurement to the local level reference frame using this estimate:

a_{m,k}^{l}=[r₁(\hat{q}ₖ⁺) r₂(\hat{q}ₖ⁺)]^{T}a_{m,k} (57)

Accelerometer measurement filtering logic 204 may process the local level acceleration measurements using a low pass filter to reduce the amplitude of higher harmonics. The low pass filter may be represented as:

$${a}_{k + 1}^{f} = γ {}_{f}^{}{a}{}_{k}^{f} + ( 1 - {γ}_{f} ) {a}_{m , k}^{l} \\ {a}_{k}^{f} = [ \begin{matrix}{a}_{e , k}^{f} \\ {a}_{n , k}^{f}\end{matrix} ] \qquad ( 58 )$$

where γ is a forgetting factor. Here, the superscript f is use to denote the low-pass filtered acceleration measurements. The subscript e is used to denote acceleration measurements in the east direction of the local level reference frame and the subscript n is used to denote acceleration measurements in the north direction of the local level reference frame.

Accelerometer measurement filtering logic 204 may use a band pass filter to extract the local level acceleration at the stride frequency:

$${a}_{e , k}^{s} = ( 1 + β ) {α}_{k} {a}_{e , k - 1}^{s} - β {a}_{e , k - 2}^{s} + \frac{1 - β}{2} ( {a}_{e , k + 1}^{f} - {a}_{e , k - 1}^{f} ) \\ {a}_{n , k}^{s} = ( 1 + β ) {α}_{k} {a}_{n , k - 1}^{s} - β {a}_{n , k - 2}^{s} + \frac{1 - β}{2} ( {a}_{n , k + 1}^{f} - {a}_{n , k - 1}^{f} ) \qquad ( 59 )$$

Here, β=exp(−2πf₀ζT₀) is the damping ratio of the discrete-time oscillator, where ζ is the continuous-time damping ratio, f₀ is the a priori estimate of the stride frequency (Hz) and T₀ is the nominal sample time (s). The parameter αₖ=cos(2π\hat{f}ₖT₀) is based on the current estimate of the stride frequency \hat{f}ₖ. It is to be understood that, as used herein, the term “stride frequency” is intended to broadly encompass any rhythmical frequency of motion associated with any form of pedestrian locomotion (including but not limited to walking, running, roller-skating, roller-blading, skateboarding, bicycling and the like).

Accelerometer measurement filtering logic 204 may estimate the stride frequency in a variety of ways. In one approach, an adaptive frequency tracking algorithm is used. In another approach, a Fast Fourier Transform (FFT) of the most recent accelerometer measurements is used. Still other approaches may be used to estimate the stride frequency.

Since the stride frequency can vary with time and the individual, the stride frequency may be estimated simultaneously. Either of the two algorithms mentioned above may be used to determine this estimate. The stride frequency may be updated only when it is determined that walking (or other pedestrian motion) is taking place.

The first method mentioned for estimating stride frequency mentioned above is an adaptive frequency-tracking algorithm (extended to two signals). The stride frequency is not estimated directly. Rather, the parameter αₖ is updated directly:

$${α}_{k + 1} = {α}_{k} + \frac{1 - ɛ}{4 {P}_{e , k}} {a}_{e , k}^{f} ( {a}_{e , k + 1}^{f} - 2 {α}_{k} {a}_{e , k}^{f} + {a}_{e , k - 1}^{f} ) + \frac{1 - ɛ}{2 {P}_{n , k}} {a}_{n , k}^{f} ( {a}_{n , k + 1}^{f} - 2 {α}_{k} {a}_{n , k}^{f} + {a}_{n , k - 1}^{f} ) \\ {P}_{e , k} = ɛ {P}_{e , k - 1} + ( 1 - ɛ ) {( {a}_{e , k}^{f} )}^{2} \\ {P}_{n , k} = ɛ {P}_{n , k - 1} + ( 1 - ɛ ) {( {a}_{n , k}^{f} )}^{2} \qquad ( 60 )$$

The values ζ and ε are design parameters chosen to control the rate of convergence and stability of the adaptive algorithm. If needed, the estimate of the stride can be computed as:

$${\hat{f}}_{k} = \frac{1}{2 π {T}_{k}} {cos}^{- 1} ( {α}_{k} ) \qquad ( 61 )$$

The second method for estimating stride frequency mentioned above uses the FFT of the most recent accelerometer measurements to estimate the stride frequency. Assume the stride frequency estimate is to lie between fₗ>0 and fᵤ Hz. At sample k, let a_{N}_{ₛ}_{,k} denote the Nₛ+1 vector containing the most recent Nₛ+1 norms of the accelerometer measurements:

a_{N}_{ₛ}_{,k}[∥a_{m,k-N}_{ₛ}∥ ∥a_{m,k-N}_{ₛ}₊₁∥ . . . ∥a_{m,k}∥] (62)

Define the FFT of a_{N}_{ₛ}_{,k} to be the Nₛ+1 vector ã_{N}_{ₛ}_{,k}:

$${\tilde{a}}_{{N}_{s} , k} = [ \begin{matrix}{\tilde{a}}_{0 , k} & {\tilde{a}}_{1 , k} & … & {\tilde{a}}_{{N}_{s} , k}\end{matrix} ] \qquad ( 63 )$$

The minimal and maximal indices corresponding to fₘᵢₙ and fₘₐₓ are:

$${i}_{l} = max \{ ⌊ {T}_{0} {N}_{s} {f}_{l} ⌋ , 2 \} \\ {i}_{u} = min \{ ⌈ {T}_{0} {N}_{s} {f}_{u} ⌉ , \frac{{N}_{s}}{2} \} \qquad ( 64 )$$

Let i_{max,k} be the index of the maximal norm element of ã_{N}_{ₛ}_{,k} between these indices:

$${i}_{max , k} = arg {max}_{{i}_{l} \leq i \leq {i}_{u}} \vert {\tilde{a}}_{i , k} \vert \qquad ( 65 )$$

The index i_{max,k} corresponds to the stride frequency that would be estimated from this window of data:

$${\tilde{f}}_{k} = \frac{{i}_{max , k}}{{T}_{0} {N}_{s}} \qquad ( 66 )$$

The parameter aₖ used in (59) to extract the stride frequency component of the local level acceleration is then:

αₖ=cos(2π\hat{f}ₖT₀).

The processing of the accelerometer measurements by accelerometer measurement filtering logic 204 results in the extraction of the walking mode, m, at the stride frequency.

II.C Direction Estimation Logic 206

The components of the walking mode parallel to and orthogonal to the walking direction will be approximately sinusoidal, with the parallel component significantly larger than the orthogonal component. In the local level reference frame, the east/north components will trace out an ellipse. The semi-major axis of this ellipse is parallel to the walking direction. Direction estimation logic 206 leverages this insight to determine the walking direction. In particular, direction estimation logic 206 determines the heading angle of the semi-major access and determines the walking direction based on the heading angle.

Two exemplary approaches by which direction estimation logic 206 may extract the heading angle of the semi-major axis will now be described. In accordance with a first approach, a subset of recent data points are identified, an ellipse is fit to the data points, and then the semi-major axis of the ellipse is computed. Let [symbol] {k₀,k_{now}} denote the indices of the samples to be used for the fit with k_{now} being the current sample and k₀ the first sample of the subset. An ellipse through point [a_{e,k}^{s} a_{n,k}^{s}] satisfies the equation:

(a_{e,k}^{s})²+Aa_{e,k}^{s}a_{n,k}^{s}+B(a_{n,k}^{s})²+Ca_{e,k}^{s}+Da_{n,k}^{s}+E=0 (67)

The ellipse that best fits the processed accelerations in the subset defined by the indices k minimizes the sum of the distances from the subset points to the ellipse:

$${min}_{\{ A , B , C , D , E \}} {\sum }_{k ∈} {( {( {a}_{e , k}^{s} )}^{2} + A {a}_{e , k}^{s} {a}_{n , k}^{s} + {B ( {a}_{n , k}^{s} )}^{2} + C {a}_{e , k}^{s} + D {a}_{n , k}^{s} + E )}^{2} \qquad ( 68 )$$

This can be expressed as a linear least-squares problem:

$$\begin{matrix}{min}_{x} {‖ Ax - b ‖}^{2} & ( 69 ) \\ where & \\ A = [ \begin{matrix}{a}_{e , {k}_{0}}^{s} {a}_{n , {k}_{0}}^{s} & {( {a}_{n , {k}_{0}}^{s} )}^{2} & {a}_{e , {k}_{0}}^{s} & {a}_{n , {k}_{0}}^{s} & 1 \\ {a}_{e , {k}_{0 + 1}}^{s} {a}_{n , {k}_{0 + 1}}^{s} & {( {a}_{n , {k}_{0 + 1}}^{s} )}^{2} & {a}_{e , {k}_{0 + 1}}^{s} & {a}_{n , {k}_{0 + 1}}^{s} & 1 \\ ⋮ & ⋮ & ⋮ & ⋮ & ⋮ \\ {a}_{e , {k}_{now}}^{s} {a}_{n , {k}_{now}}^{s} & {( {a}_{n , {k}_{now}}^{s} )}^{2} & {a}_{e , {k}_{now}}^{s} & {a}_{n , {k}_{now}}^{s} & 1\end{matrix} ] \\ x = [ \begin{matrix}A \\ B \\ C \\ D \\ E\end{matrix} ] b = [ \begin{matrix}- {( {a}_{e , {k}_{0}}^{s} )}^{2} \\ - {( {a}_{e , {k}_{0 + 1}}^{s} )}^{2} \\ ⋮ \\ - {( {a}_{e , {k}_{now}}^{s} )}^{2}\end{matrix} ] & ( 70 )\end{matrix}$$

The solution to this linear least-squares problem is standard.

The heading angle of the semi-major axis at time index k_{now} is:

\hat{γ}ₖ_{_{now}}=−1/2 tan₂⁻¹(1−B,A) (71)

where −180°<tan₂⁻¹(x,y)≦180° is the 4-quadrant arc tangent function. The center of the ellipse x_{c}=[x_{c} y_{c}] is:

$${x}_{c , {k}_{now}} = [ \begin{matrix}\frac{AD - 2 BC}{4 B - {A}^{2}} & \frac{A C - 2 D}{4 B - {A}^{2}}\end{matrix} ] \qquad ( 72 )$$

In accordance with a second approach, a subset of recent data points corresponding to an integer number of cycles is identified and a straight line is fit to them. The slope of the line defines the heading angle of the semi-major axis. Let [symbol] {k₀, k_{now}} denote the indices of the samples to be used for the fit with k_{now} being the current sample and k₀=2πl/ωₖTₖ the first sample of the subset for integer l.

The best-fit straight line that minimizes the distance from the data to the line is defined by the slope s and the y-intercept y_{c}:

$${min}_{\{ m , {y}_{c} \}} {\sum }_{k ∈} {( {ma}_{e , k}^{s} + {y}_{c} - {a}_{n , k}^{s} )}^{2} \qquad ( 73 )$$

This can be expressed as a linear least-squares problem:

$$\begin{matrix}{min}_{x} {‖ Ax - b ‖}^{2} & ( 74 ) \\ where & \\ A = [ \begin{matrix}{a}_{e , {k}_{0}}^{s} & 1 \\ {a}_{e , {k}_{0 + 1}}^{s} & 1 \\ ⋮ & ⋮ \\ {a}_{e , {k}_{now}}^{s} & 1\end{matrix} ] x = [ \begin{matrix}m \\ {y}_{c}\end{matrix} ] b = [ \begin{matrix}{a}_{n , {k}_{0}}^{s} \\ {a}_{n , {k}_{0} + 1}^{s} \\ ⋮ \\ {a}_{n , {k}_{now}}^{s}\end{matrix} ] & ( 75 )\end{matrix}$$

The heading angle of the semi-major axis of the ellipse at time index k_{now} is:

\hat{γ}ₖ_{_{now}}=90°−tan⁻¹(m) (76)

where −90°<tan⁻¹(x)≦90° is the arctangent function. The center of the ellipse is approximately:

x_{c,k}_{_{now}}=[0 y_{c}] (77)

The heading angle \hat{γ} ((71) or (76)) and \hat{γ}+180° both define the angle of the semi-major axis of the ellipse. Thus, either could be the walking direction. The 180 degree ambiguity can be resolved in a number of ways. In one approach, Wi-Fi location is first calculated in both [opposite] directions. By noting known WiFi locations, the ambiguity can be resolved in favor of the calculated location being closer to the identified location of the WiFi. Modern WiFi technology has a range of 70 meters [indoors] to 250 meters [outdoors]. The location method described here will be substantially more accurate than using the WIFI location. GPS can also be used to resolve the ambiguity if GPS is available and if battery limitations permit. In certain embodiments, such GPS use would be infrequent and use minimal battery power.

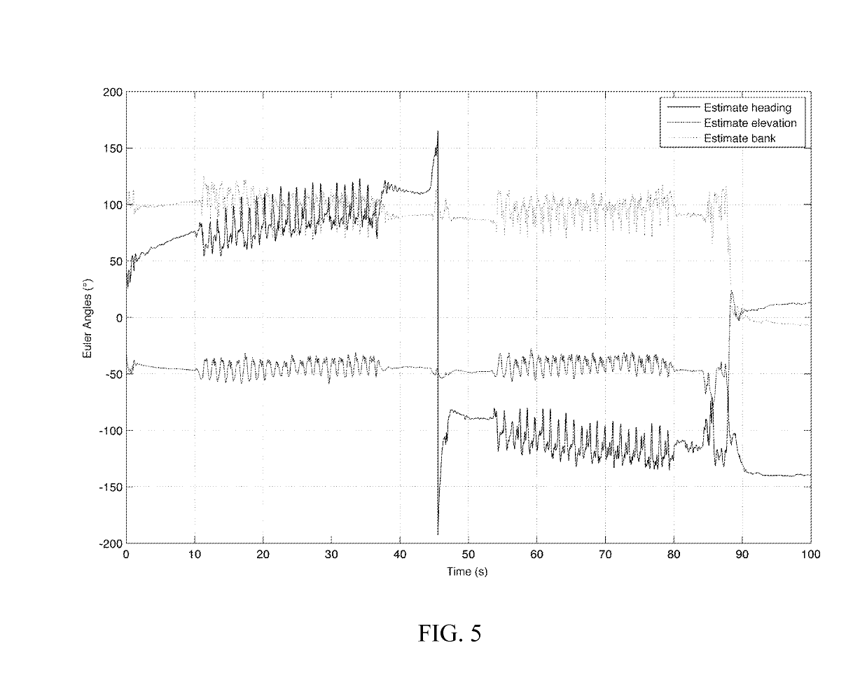

FIG. 5 is a graphical representation 500 of Euler angles estimated by applying an embodiment of the foregoing direction of motion estimation algorithm to data generated by non-GPS navigational components. In graphical representation 500, the heading angle is relative to magnetic north.

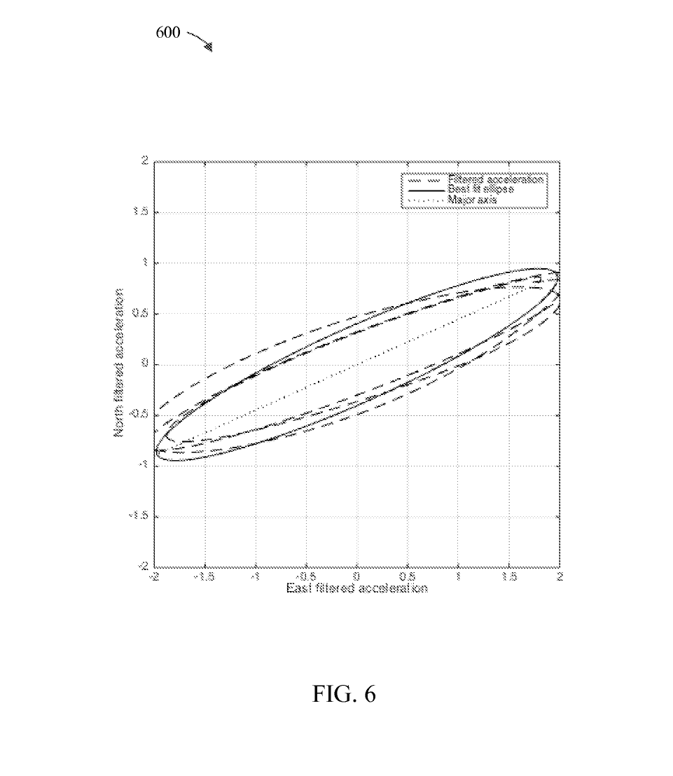

FIG. 6 is a graphical representation 600 of phase plots of north filtered acceleration (i.e., frequency components that represent northward acceleration at the estimated stride frequency) vs. east filtered acceleration (i.e., frequency components that represent eastward acceleration at the estimated stride frequency) obtained by applying equation (59) to a series of local level acceleration measurements in accordance with the foregoing method. In particular, in graphical representation 600, the dashed lines labelled “filtered accelerations” represent the phase plots. The solid line represents the best fit ellipse identified by applying equations (69)-(70) to the data shown in the phase plot. The dotted line represents the major axis of this ellipse. The angle of its slope is given by equation (73).

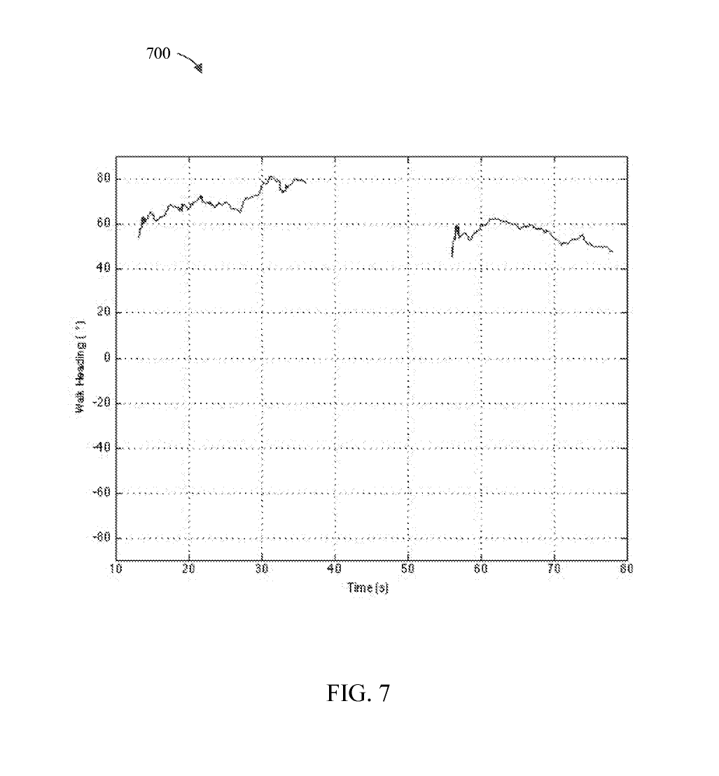

FIG. 7 is a graphical representation 700 of direction of motion (heading relative to true north) angles estimated by applying an embodiment of the foregoing direction of motion estimation algorithm to data generated by non-GPS navigational components. In graphical representation 700, there are two segments of pedestrian motion: approximately 12-35 s and 55-75 s. The direction of motion is not estimated for other times. The true heading angle for the first segment should be about 70° and for the second segment about 250°. The second segment illustrates the 180° ambiguity.

II.D Example Applications of Direction of Motion Determination Logic

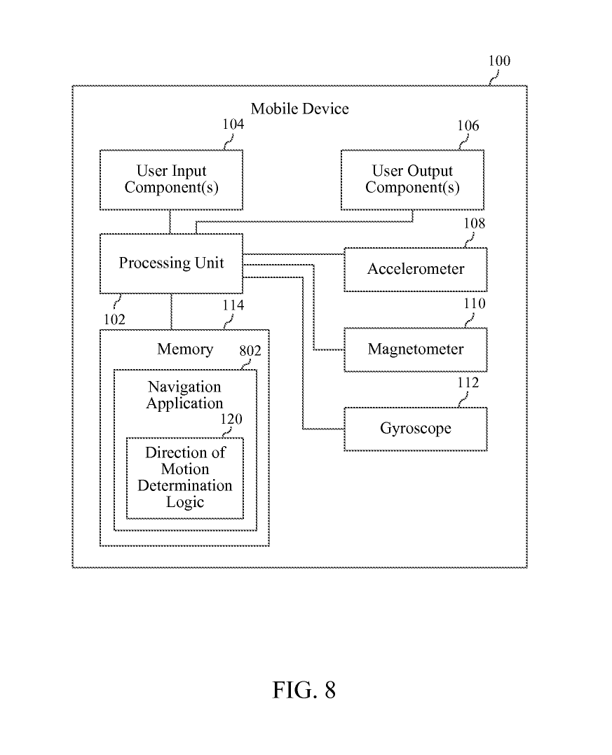

The estimated direction of motion generated by direction of motion determination logic 120 may be utilized for a variety of purposes by a variety of software programs (e.g., one or more software applications executing on mobile device 100). FIG. 8 depicts an embodiment of mobile device 100 in which direction of motion determination logic 120 comprises part of a navigation application 802 that may be executed on mobile device 100. By way of example only and without limitation, navigation application 802 may comprise a maps application, a compass application, a consumer services locator application, a fitness application, a travel guide application, a geocaching application, or the like. Navigation application 802 may cause the direction of motion that is estimated by direction of motion determination logic 120, or information derived therefrom, to be presented to user of mobile device 100 via one or more of user output component(s) 106 (e.g., via a display).

In one embodiment, navigation application 802 combines direction of motion estimates provided by direction of motion determination logic 120 with stride-length and number-of-steps estimates to produce an ongoing position estimate. The ongoing position estimate may be presented to a user of mobile device 100 via one or more of user output component(s) 106 (e.g., via a display). In further embodiments, navigation application 802 further enhances or augments the position estimate with other sensor data (such as GPS or Wi-Fi) when that sensor data is available.

Navigation application 802 may be configured to selectively utilize direction of motion determination logic 120. For example, navigation application 802 may be configured to utilize direction of motion determination logic 120 only when it is determined that GPS signals, Wi-Fi_33 signals, cellular signals, or other signals that may be relied upon for determining a position of a user are unavailable. As another example, navigation application 802 may be configured to utilize direction of motion determination logic 120 only when it is determined that the user of mobile device 100 is travelling by means of their feet (e.g., walking, running, roller-skating, roller-blading, skateboarding, bicycling or the like). Navigation application 802 may determine the travel mode of the user via explicit user input received via one or more of user input component(s) 104 (e.g., a user actively selects a pedestrian mode via a GUI of navigation application 802) or may infer the travel mode of the user based on input received from one or more navigational components of mobile device 100.

In alternate embodiments, direction of motion determination logic 120 may not comprise part of navigation application 802. For example, direction of motion determination logic 120 may comprise logic that is separate from navigation application 802. Such logic may be invoked (e.g., as a service) by navigation application 802 when an estimate of the direction of motion of mobile device 100 is needed. In further accordance with such an implementation, direction of motion determination logic 120 may comprise a component that is installed on mobile device 100 and can be invoked by a plurality of different applications via a common application programming interface (API) to obtain therefrom direction of motion information (or other information that can be derived therefrom).

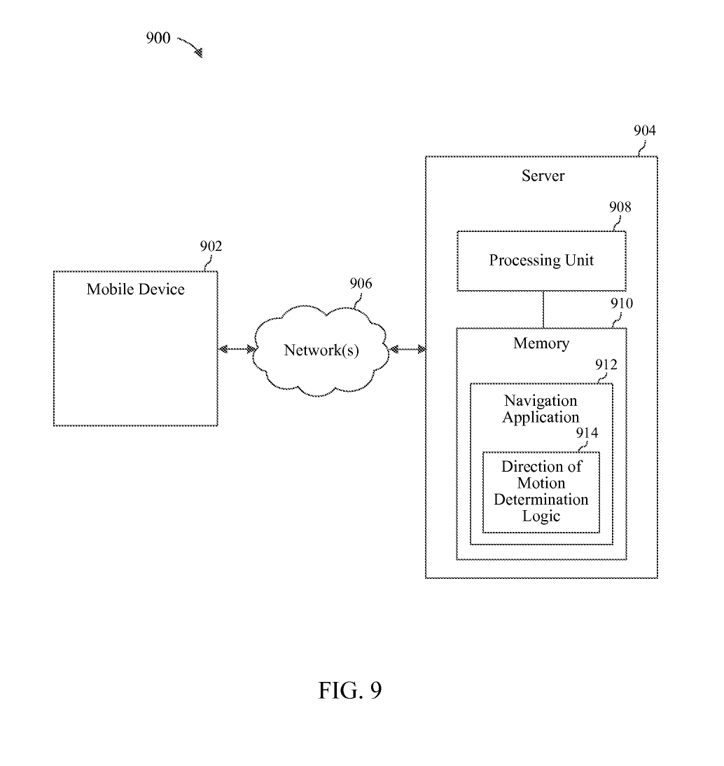

It is further noted that the direction of motion determination logic may be executed remotely from mobile device 100. FIG. 9 is a block diagram of a client-server system 900 that operates in this manner. As shown in FIG. 9, system 900 includes a mobile device 902 and a server 904. Mobile device 902 is communicatively connected to server 904 via one or more wired or wireless networks 906.

At server 904, a processing unit 908 executes a navigation application 912 that is stored in memory 910. Navigation application 912 may comprise an on-line application that is accessed by a user of mobile device 902. For example, a user of mobile device 902 may interact with navigation application 912 via a Web browser or other suitable interface presented by mobile device 902. Navigation application 912 includes direction of motion determination logic 914.

Mobile device 902 collects measurement data (e.g., accelerometer, magnetometer and gyroscope measurement data) and intermittently or periodically transmits the measurement data to navigation application 912 executing on server 904 via network(s) 906. Direction of motion determination logic 914 processes such data to intermittently or periodically estimate a direction of motion of a user of mobile device 902 in a manner that was previously described. Navigation application 912 may cause the direction of motion or information derived therefrom to be presented to the user of mobile device 902 by sending such information to mobile device 902 via network(s) 906.

Still other methods of implementation are possible. For example, a navigation application may be executed locally on mobile device 100 and place calls to direction of motion determination logic that is executed on a remote machine. In another example implementation, sensor data may be captured over time by mobile device 100 and then provided (e.g., as a file) to direction of motion determination logic executing on another device to recreate pedestrian direction of motion and position estimates after the fact (as opposed to a more real-time approach).

II.E Example Method for Automatically Determining Direction of Motion of a Pedestrian

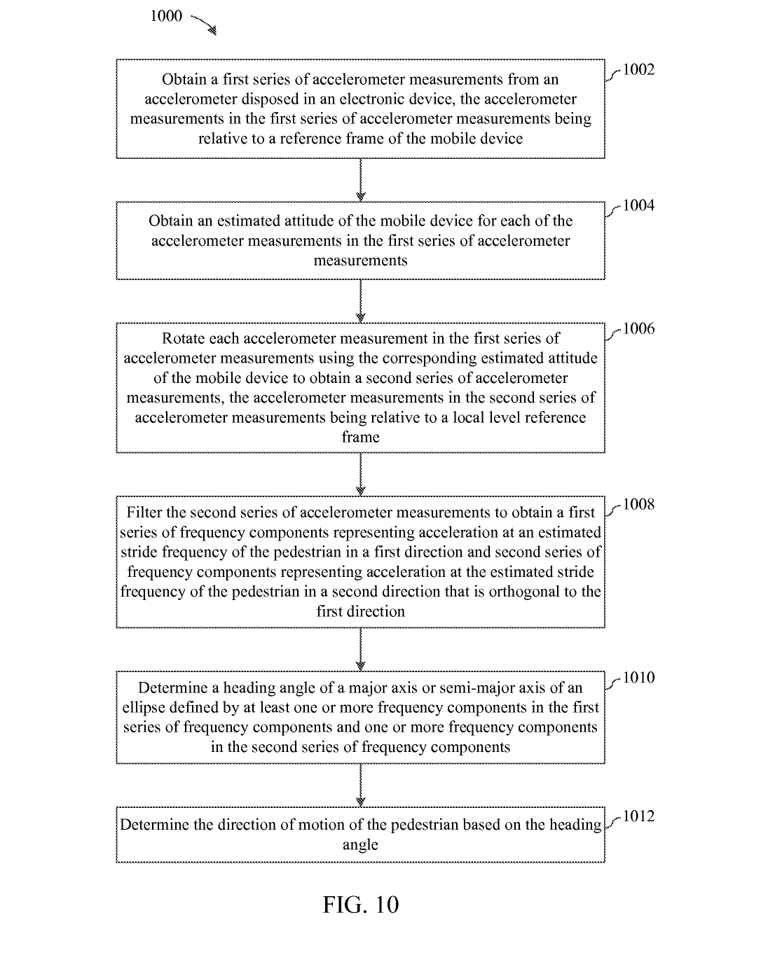

FIG. 10 depicts a flowchart 1000 of an example method for determining a direction of motion of a pedestrian. The method of flowchart 1000 may be performed, for example, by direction of motion determination logic 120 as described above in reference to FIGS. 1 and 8 or by direction of motion determination logic 914 as described above in reference to FIG. 9. However, the method is not limited to those implementations.

As shown in FIG. 10, the method of flowchart 1000 begins at step 1002, in which a first series of accelerometer measurements is obtained from an accelerometer disposed in a mobile device. The mobile device may comprise, for example, an electronic device worn or carried by the pedestrian. The accelerometer measurements in the first series of accelerometer measurements are relative to a reference frame of the mobile device.

At step 1004, an estimated attitude of the mobile device is obtained for each of the accelerometer measurements in the first series of accelerometer measurements. In one embodiment, the estimated attitude is obtained based on one or more accelerometer measurements obtained from the accelerometer, one or more magnetometer measurements obtained from a magnetometer disposed in the mobile device, and one or more gyroscope measurements obtained from a gyroscope disposed in the mobile device. An example of such an embodiment was described above in Section II.A. It is noted that in certain implementations, the estimated attitude may be obtained without using gyroscope measurement data. Such an embodiment may rely on the accelerometer and magnetometer measurement data only to perform attitude estimation.

In one embodiment, obtaining the estimated attitude of the mobile device comprises processing at least the one or more accelerometer measurements and one or more magnetometer measurements in an EKF.

At step 1006, each accelerometer measurement in the first series of accelerometer measurements is rotated using the corresponding estimated attitude of the mobile device to obtain a second series of accelerometer measurements. The accelerator measurements in the second series of accelerator measurements are relative to a local level reference frame.

At step 1008, the second series of accelerometer measurements are filtered to obtain a first series of frequency components representing acceleration at an estimated stride frequency of the pedestrian in a first direction and a second series of frequency components representing acceleration at the estimated stride frequency of the pedestrian in a second direction that is orthogonal to the first direction. In an embodiment, the first direction is east and the second direction is north. However, other directions may be used.

The filtering performed during step 1008 may comprise processing the second series of accelerometer measurements by a low pass filter to generate a series of low-pass-filtered accelerometer measurements and then processing the series of low-pass-filtered accelerometer measurements by a band pass filter to produce the first series of frequency components and the second series of frequency components.

At step 1010, a heading angle of a major axis or a semi-major axis of an ellipse defined at least by one or more frequency components in the first series of frequency components and one or more frequency components in the second series of frequency components is determined.

In an embodiment, step 1010 may be performed by identifying an ellipse that best fits at least one or more accelerometer measurements in the third series of accelerometer measurements and one or more accelerometer measurements in the fourth series of accelerometer measurements and then calculating the major axis or the semi-major axis of the identified ellipse.

In an alternate embodiment, step 1010 may be performed by identifying a straight line that best fits a subset of the frequency components in the first series of frequency components and in the second series of frequency components that correspond to an integer number of cycles and then determining a slope of the straight line.

At step 1012, the direction of motion of the pedestrian is determined based on the heading angle.

In an embodiment, the foregoing method may also include determining the estimated stride frequency. Determining the estimated stride frequency may be achieved, for example, by using an adaptive frequency tracking algorithm or by obtaining a Fast Fourier Transform of a subset of the second series of acceleration measurements.

In a further embodiment, the foregoing method may also include updating an estimated position of the pedestrian based at least on the direction of motion. This update may be performed, for example, based at least on the direction of motion, an estimated stride length of the pedestrian, and an estimated number of steps taken by the pedestrian.

In a still further embodiment, the foregoing method may further displaying the direction of motion of the pedestrian or information derived therefrom (e.g., a position of the pedestrian) on a graphical user interface of the mobile device.

### III. Example Mobile Device Implementation

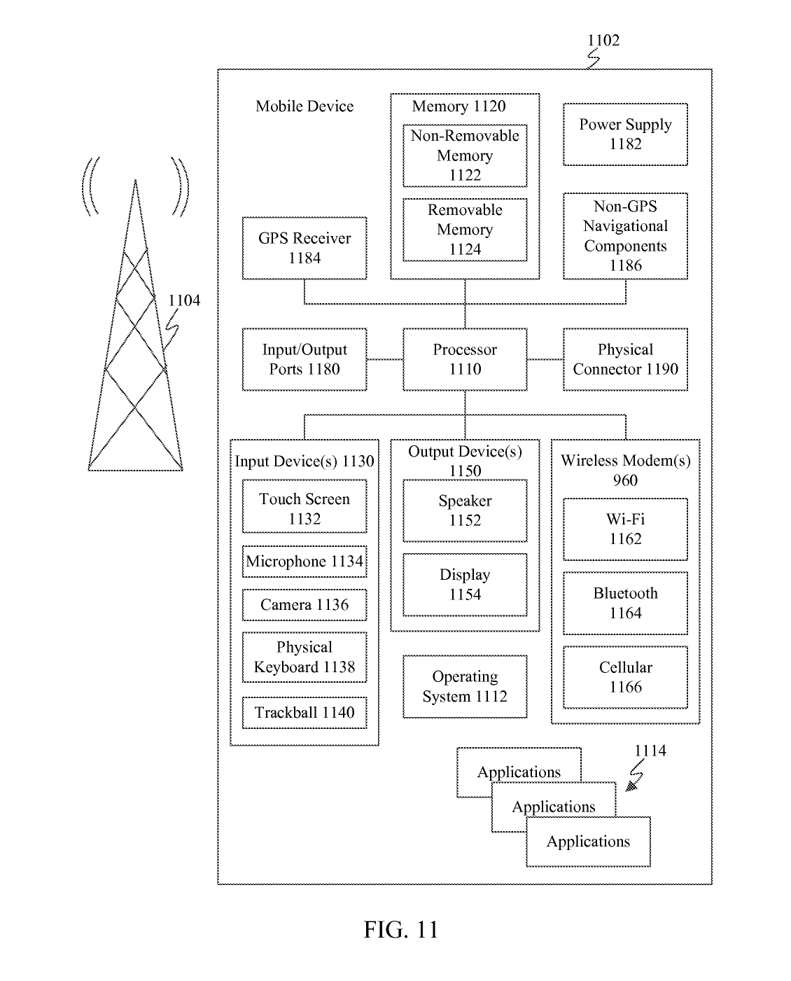

FIG. 11 is a block diagram of an exemplary mobile device 1102 that may implement embodiments described herein. As shown in FIG. 11, mobile device 1102 includes a variety of optional hardware and software components. Any component in mobile device 1102 can communicate with any other component, although not all connections are shown for ease of illustration. Mobile device 1102 can be any of a variety of computing devices (e.g., cell phone, smartphone, handheld computer, Personal Digital Assistant (PDA), etc.) and can allow wireless two-way communications with one or more mobile communications networks 1104, such as a cellular or satellite network, or with a local area or wide area network.

The illustrated mobile device 1102 can include a controller or processor 1110 (e.g., signal processor, microprocessor, ASIC, or other control and processing logic circuitry) for performing such tasks as signal coding, data processing, input/output processing, power control, and/or other functions. An operating system 1112 can control the allocation and usage of the components of mobile device 1102 and provide support for one or more application programs 1114 (also referred to as “applications” or “apps”). Application programs 1114 may include common mobile computing applications (e.g., e-mail applications, calendars, contact managers, Web browsers, messaging applications) and any other computing applications (e.g., word processing applications, mapping applications, media player applications).

The illustrated mobile device 1102 can include memory 1120. Memory 1120 can include non-removable memory 1122 and/or removable memory 1124. Non-removable memory 1122 can include RAM, ROM, flash memory, a hard disk, or other well-known memory devices or technologies. Removable memory 1124 can include flash memory or a Subscriber Identity Module (SIM) card, which is well known in GSM communication systems, or other well-known memory devices or technologies, such as “smart cards.” Memory 1120 can be used for storing data and/or code for running operating system 1112 and applications 1114. Example data can include Web pages, text, images, sound files, video data, or other data to be sent to and/or received from one or more network servers or other devices via one or more wired or wireless networks. Memory 1120 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

Mobile device 1102 can support one or more input devices 1130, such as a touch screen 1132, a microphone 1134, a camera 1136, a physical keyboard 1138 and/or a trackball 1140 and one or more output devices 1150, such as a speaker 1152 and a display 1154. Other possible output devices (not shown) can include piezoelectric or other haptic output devices. Some devices can serve more than one input/output function. For example, touch screen 1132 and display 1154 can be combined in a single input/output device. The input devices 1130 can include a Natural User Interface (NUI).

Wireless modem(s) 1160 can be coupled to antenna(s) (not shown) and can support two-way communications between the processor 1110 and external devices, as is well understood in the art. The modem(s) 1160 are shown generically and can include a cellular modem 1166 for communicating with the mobile communication network 1104 and/or other radio-based modems (e.g., Bluetooth 1164 and/or Wi-Fi 1162). At least one of the wireless modem(s) 1160 is typically configured for communication with one or more cellular networks, such as a GSM network for data and voice communications within a single cellular network, between cellular networks, or between the mobile device and a public switched telephone network (PSTN).

Mobile device 1102 can further include at least one input/output port 1180, a power supply 1182, a satellite navigation system receiver 1184, such as a Global Positioning System (GPS) receiver, various non-GPS navigational components 1186 (e.g., an accelerometer, a magnetometer, and a gyroscope), and/or a physical connector 1190, which can be a USB port, IEEE 1394 (FireWire) port, and/or RS-232 port. The illustrated components of mobile device 1102 are not required or all-inclusive, as any components can be deleted and other components can be added as would be recognized by persons skilled in the relevant art(s).

In an embodiment, mobile device 1102 is configured to perform any of the functions of mobile device 100 as described above in reference to FIGS. 1 and 8 or mobile device 902 as described above in reference to FIG. 9. Computer program logic for performing the functions of these devices may be stored in memory 1120 and executed by processor 1110. By executing such computer program logic, processor 1110 may be caused to implement any of the features of any of these devices. Also, by executing such computer program logic, processor 1110 may be caused to perform any or all of the steps of any or all of the flowcharts depicted in FIG. 4 or 10.

### IV. Example Computer System Implementation

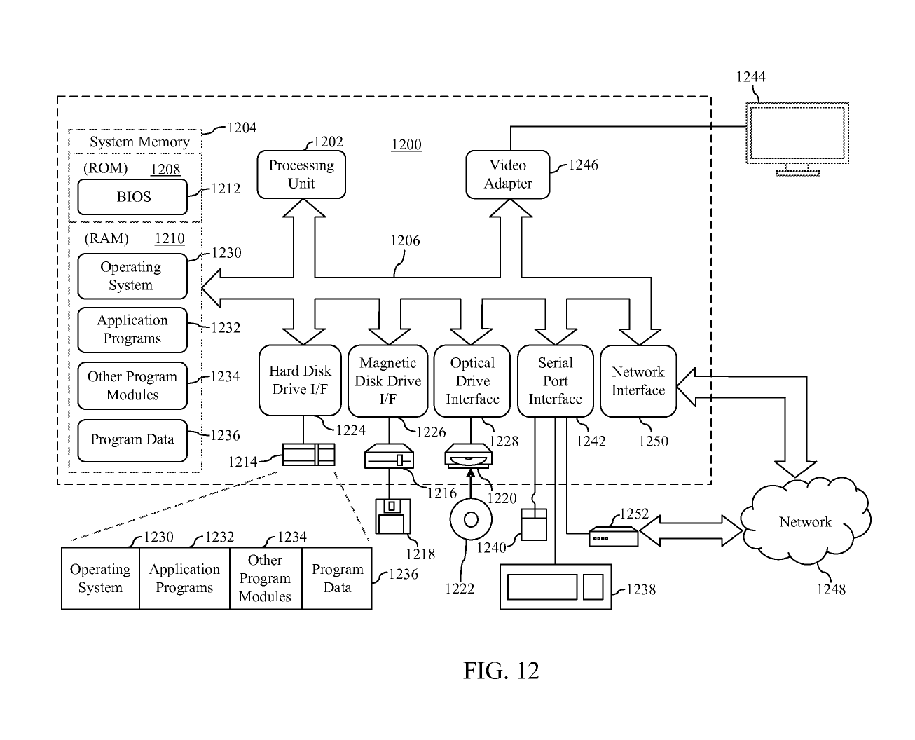

FIG. 12 depicts an example processor-based computer system 1200 that may be used to implement various embodiments described herein. For example, system 1200 may be used to implement mobile device 100 as described above in reference to FIGS. 1 and 8, mobile device 902 as described above in reference to FIG. 9, or server 904 as described above in reference to FIG. 9. System 1200 may also be used to implement any or all of the steps of any or all of the flowcharts depicted in FIGS. 4 and 10. The description of system 1200 provided herein is provided for purposes of illustration, and is not intended to be limiting. Embodiments may be implemented in further types of computer systems, as would be known to persons skilled in the relevant art(s).

As shown in FIG. 12, system 1200 includes a processing unit 1202, a system memory 1204, and a bus 1206 that couples various system components including system memory 1204 to processing unit 1202. Processing unit 1202 may comprise one or more microprocessors or microprocessor cores. Bus 1206 represents one or more of any of several types of bus structures, including a memory bus or memory controller, a peripheral bus, an accelerated graphics port, and a processor or local bus using any of a variety of bus architectures. System memory 1204 includes read only memory (ROM) 1208 and random access memory (RAM) 1210. A basic input/output system 1212 (BIOS) is stored in ROM 1208.

System 1200 also has one or more of the following drives: a hard disk drive 1214 for reading from and writing to a hard disk, a magnetic disk drive 1216 for reading from or writing to a removable magnetic disk 1218, and an optical disk drive 1220 for reading from or writing to a removable optical disk 1222 such as a CD ROM, DVD ROM, BLU-RAY™ disk or other optical media. Hard disk drive 1214, magnetic disk drive 1216, and optical disk drive 1220 are connected to bus 1206 by a hard disk drive interface 1224, a magnetic disk drive interface 1226, and an optical drive interface 1228, respectively. The drives and their associated computer-readable media provide nonvolatile storage of computer-readable instructions, data structures, program modules and other data for the computer. Although a hard disk, a removable magnetic disk and a removable optical disk are described, other types of computer-readable memory devices and storage structures can be used to store data, such as flash memory cards, digital video disks, random access memories (RAMs), read only memories (ROM), and the like.

A number of program modules may be stored on the hard disk, magnetic disk, optical disk, ROM, or RAM. These program modules include an operating system 1230, one or more application programs 1232, other program modules 1234, and program data 1236. In accordance with various embodiments, the program modules may include computer program logic that is executable by processing unit 1202 to perform any or all of the functions and features of mobile device 100 as described above in reference to FIGS. 1 and 8, mobile device 902 as described above in reference to FIG. 9, or server 904 as described above in reference to FIG. 9. The program modules may also include computer program logic that, when executed by processing unit 1202, performs any of the steps or operations shown or described in reference to the flowcharts of FIGS. 4 and 10.

A user may enter commands and information into system 1200 through input devices such as a keyboard 1238 and a pointing device 1240 (e.g., a mouse). Other input devices (not shown) may include a microphone, joystick, game controller, scanner, or the like. In one embodiment, a touch screen is provided in conjunction with a display 1244 to allow a user to provide user input via the application of a touch (as by a finger or stylus for example) to one or more points on the touch screen. These and other input devices are often connected to processing unit 1202 through a serial port interface 1242 that is coupled to bus 1206, but may be connected by other interfaces, such as a parallel port, game port, or a universal serial bus (USB). Such interfaces may be wired or wireless interfaces.

Display 1244 is connected to bus 1206 via an interface, such as a video adapter 1246. In addition to display 1244, system 1200 may include other peripheral output devices (not shown) such as speakers and printers.

System 1200 is connected to a network 1248 (e.g., a local area network or wide area network such as the Internet) through a network interface 1250, a modem 1252, or other suitable means for establishing communications over the network. Modem 1252, which may be internal or external, is connected to bus 1206 via serial port interface 1242.

As used herein, the terms “computer program medium,” “computer-readable medium,” and “computer-readable storage medium” are used to generally refer to memory devices or storage structures such as the hard disk associated with hard disk drive 1214, removable magnetic disk 1218, removable optical disk 1222, as well as other memory devices or storage structures such as flash memory cards, digital video disks, random access memories (RAMs), read only memories (ROM), and the like. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

As noted above, computer programs and modules (including application programs 1232 and other program modules 1234) may be stored on the hard disk, magnetic disk, optical disk, ROM, or RAM. Such computer programs may also be received via network interface 1250, serial port interface 1242, or any other interface type. Such computer programs, when executed or loaded by an application, enable system 1200 to implement features of embodiments discussed herein. Accordingly, such computer programs represent controllers of the system 1200.

Embodiments are also directed to computer program products comprising software stored on any computer useable medium. Such software, when executed in one or more data processing devices, causes a data processing device(s) to operate as described herein. Embodiments may employ any computer-useable or computer-readable medium, known now or in the future. Examples of computer-readable mediums include, but are not limited to memory devices and storage structures such as RAM, hard drives, floppy disks, CD ROMs, DVD ROMs, zip disks, tapes, magnetic storage devices, optical storage devices, MEMs, nanotechnology-based storage devices, and the like.

### V. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention as defined in the appended claims. Thus, the breadth and scope of the present invention should not be limited by any of the above-described exemplary embodiments, but should be defined only in accordance with the following claims and their equivalents.

What is claimed is:

1. An automated method for determining a direction of motion of a pedestrian, comprising:
obtaining a first series of accelerometer measurements from an accelerometer disposed in a mobile device, the accelerometer measurements in the first series of accelerometer measurements being relative to a reference frame of the mobile device;
obtaining an estimated attitude of the mobile device for each of the accelerometer measurements in the first series of accelerometer measurements;
rotating each accelerometer measurement in the first series of accelerometer measurements using the corresponding estimated attitude of the mobile device to obtain a second series of accelerometer measurements, the accelerator measurements in the second series of accelerator measurements being relative to a local level reference frame;
filtering the second series of accelerometer measurements to obtain a first series of frequency components representing acceleration at an estimated stride frequency of the pedestrian in a first direction and a second series of frequency components representing acceleration at the estimated stride frequency of the pedestrian in a second direction that is orthogonal to the first direction;
determining a heading angle of a major axis or a semi-major axis of an ellipse defined at least by one or more frequency components in the first series of frequency components and one or more frequency components in the second series of frequency components; and
determining the direction of motion of the pedestrian based on the heading angle.

2. The method of claim 1, wherein determining the direction of motion of the pedestrian comprises determining the direction of motion of person who is walking, running, roller-skating, roller-blading, skateboarding or bicycling.

3. The method of claim 1, wherein the mobile device comprises an electronic device worn or carried by the pedestrian.

4. The method of claim 1, wherein obtaining the estimated attitude of the mobile device for each of the accelerometer measurements in the first series of accelerometer measurements comprises:
obtaining an estimated attitude of the mobile device based at least on one or more accelerometer measurements obtained from the accelerometer and one or more magnetometer measurements obtained from a magnetometer disposed in the mobile device.

5. The method of claim 4, wherein obtaining the estimated attitude of the mobile device for each of the accelerometer measurements in the first series of accelerometer measurements comprises:
obtaining the estimated attitude of the mobile device based on the one or more accelerometer measurements obtained from the accelerometer, the one or more magnetometer measurements obtained from the magnetometer, and one or more gyroscope measurements obtained from a gyroscope disposed in the mobile device.

6. The method of claim 4, wherein obtaining the estimated attitude of the mobile device for each of the accelerometer measurements in the first series of accelerometer measurements comprises:
processing at least the one or more accelerometer measurements and the one or more magnetometer measurements in an extended Kalman filter.

7. The method of claim 1, wherein the filtering comprises:
processing the second series of accelerometer measurements by a low pass filter to generate a series of low-pass-filtered accelerometer measurements; and
processing the series of low-pass-filtered accelerometer measurements by a band pass filter to produce the first series of frequency components and the second series of frequency components.

8. The method of claim 1, wherein the first direction is east and the second direction is north.

9. The method of claim 1, further comprising:
determining the estimated stride frequency by using an adaptive frequency tracking algorithm or by obtaining a Fast Fourier Transform of a subset of the second series of acceleration measurements

10. The method of claim 1, wherein determining the heading angle of the major axis or the semi-major axis of the ellipse comprises:
identifying an ellipse that best fits at least one or more accelerometer measurements in the third series of accelerometer measurements and one or more accelerometer measurements in the fourth series of accelerometer measurements; and
calculating the major axis or the semi-major axis of the identified ellipse.

11. The method of claim 1, wherein determining the heading angle of the major axis or the semi-major axis of the ellipse comprises:
identifying a straight line that best fits a subset of the frequency components in the first series of frequency components and in the second series of frequency components that correspond to an integer number of cycles; and
determining a slope of the straight line.

12. The method of claim 1, wherein one or more of the steps are performed by one or more processors disposed within the mobile device.

13. The method of claim 1, wherein one or more of the steps are performed by a computing device that is communicatively connected to the mobile device.

14. The method of claim 1, further comprising:
updating an estimated position of the pedestrian based at least on the direction of motion.

15. The method of claim 14, wherein updating the estimated position of the pedestrian based at least on the direction of motion comprises:
updating the estimated position of the pedestrian based at least on the direction of motion, an estimated stride length of the pedestrian, and an estimated number of steps taken by the pedestrian.

16. The method of claim 1, further comprising:
displaying the direction of motion of the pedestrian or information derived therefrom on a graphical user interface of the mobile device.

17. A mobile device, comprising:
one or more processors;
an accelerometer connected to the one or more processors; and
a memory connected to the one or more processors, the memory storing computer program logic that is executable by the one or more processors to perform operations that include:
obtaining a first series of accelerometer measurements from the accelerometer, the accelerometer measurements in the first series of accelerometer measurements being relative to a reference frame of the mobile device;
converting the first series of accelerometer measurements into a second series of accelerometer measurements, the accelerator measurements in the second series of accelerator measurements being relative to a local level reference frame;
filtering the second series of accelerometer measurements to obtain a first series of frequency components representing acceleration at an estimated stride frequency of a pedestrian in a first direction and a second series of frequency components representing acceleration at the estimated stride frequency of the pedestrian in a second direction that is orthogonal to the first direction;
determining a heading angle of a major axis or a semi-major axis of an ellipse defined at least by one or more frequency components in the first series of frequency components and one or more frequency components in the second series of frequency components; and
determining a direction of motion of the pedestrian based on the heading angle.

18. The mobile device of claim 17, further comprising:
a magnetometer connected to the one or more processors; and
a gyroscope connected to the one or more processors;
wherein converting the first series of accelerometer measurements into a second series of accelerometer measurements comprises:
obtaining an estimated attitude of the mobile device for each of the accelerometer measurements in the first series of accelerometer measurements based at least on one or more accelerometer measurements obtained from the accelerometer, one or more magnetometer measurements obtained from the magnetometer, and one or more gyroscope measurements obtained from the gyroscope; and
rotating each accelerometer measurement in the first series of accelerometer measurements using the corresponding estimated attitude of the mobile device to obtain the second series of accelerometer measurements.

19. The mobile device of claim 17, further comprising:
a display connected to the one or more processors;
wherein the operations further comprise presenting the direction of motion of the pedestrian or information derived therefrom via the display.

20. A computer program product comprising a computer-readable memory having computer program logic recorded thereon that when executed by at least one processor causes the at least one processor to perform a method comprising:
obtaining a first series of accelerometer measurements from an accelerometer, the accelerometer measurements in the first series of accelerometer measurements being relative to a reference frame of a mobile device;
converting the first series of accelerometer measurements into a second series of accelerometer measurements, the accelerator measurements in the second series of accelerator measurements being relative to a local level reference frame;
filtering the second series of accelerometer measurements to obtain a first series of frequency components representing acceleration at an estimated stride frequency of a pedestrian in a first direction and a second series of frequency components representing acceleration at the estimated stride frequency of the pedestrian in a second direction that is orthogonal to the first direction;
determining a heading angle of a major axis or a semi-major axis of an ellipse defined at least by one or more frequency components in the first series of frequency components and one or more frequency components in the second series of frequency components; and
determining a direction of motion of the pedestrian based on the heading angle.
